(19) United States
(12) Patent Application Publication
(10) Pub. No.: US 2018/0253808 A1
(43) Pub. Date: Sep. 6, 2018

(54) PROPERTY TRANSACTION GRADING SYSTEM

(71) Applicant: JetClosing Inc, Seattle, WA (US)

(72) Inventors: Eric T. Bloomquist, Seattle, WA (US); Andrew D. Greenshields, Seattle, WA (US); Shawna J. Hernandez, Seattle, WA (US); Arthur C. Delight, IV, Seattle, WA (US); Xiaodi Huang, Seattle, WA (US); Samuel Levine, Seattle, WA (US); Nate Eisele, Sammamish, WA (US); David Wolf, Redmond, WA (US)

(21) Appl. No.: 15/906,200

(22) Filed: Feb. 27, 2018

Related U.S. Application Data
(60) Provisional application No. 62/467,707, filed on Mar. 6, 2017.

(51) Int. Cl. G06Q 50/16; G06Q 10/06

(52) U.S. Cl. CPC G06Q 50/16; G06Q 10/0635

(57) ABSTRACT

A system comprises a machine interface to display one or more display activation controls, each comprising a status of external grading resources and configured to receive an update signal associated with the external grading resources, a machine controller, a grading processor to generate a grade control signal from the one or more resource effects associated with the external grading resources; and a resource effect control memory structure comprising the one or more resource effects.

### CROSS REFERENCE TO RELATED APPLICATIONS

This application claims the benefit of U.S. provisional patent application Ser. No. 62/467,707, filed on Mar. 3, 2017, the contents of which are incorporated by reference herein in their entirety.

### BACKGROUND

Title insurance is required to complete a purchase of real property. While purchasing real property for, it is useful to have an indication of the curative issues attached to the real property. A method and system to grade real property to manage the risk involved may increase the efficiency of a real property purchasing.

### BRIEF SUMMARY

A system and method to generate and deliver a score and corresponding letter grade on the title report of a real property in a purchase and sales transaction. This is dynamically scored, updated, and delivered to a mobile device via a cloud based system. The system may utilize data from public sources, proprietary and purchased in a calculation to determine a score/grade, which is published to database and mobile device. The method and system may utilize machine learning to analyze and inform the score/grade based on location, local trends or impacts or individuals.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a property grading system 100.

FIG. 2 illustrates an embodiment of a machine interface display 200.

FIG. 3 illustrates an embodiment of a machine interface display 300.

FIG. 4 illustrates an embodiment of a machine interface display 400.

FIG. 5 illustrates an embodiment of a machine interface display 500.

FIG. 6 illustrates an embodiment of a machine interface display 600.

FIG. 7 illustrates an embodiment of a machine interface display 700.

FIG. 8 illustrates an embodiment of a machine interface display 800.

FIG. 9 illustrates an embodiment of a machine interface display 900.

FIG. 10 illustrates an embodiment of a machine interface display 1000.

FIG. 11 illustrates an embodiment of a machine interface display 1100.

FIG. 12 illustrates an embodiment of a machine interface display 1200.

FIG. 13 illustrates an embodiment of a machine interface display 1300.

FIG. 14 illustrates an embodiment of a machine interface display 1400.

FIG. 15 illustrates an embodiment of a machine interface display 1500.

FIG. 16 illustrates an embodiment of a machine interface display 1600.

FIG. 17 illustrates an embodiment of a machine interface display 1700.

FIG. 18 illustrates an embodiment of a scoring method 1800.

FIG. 19 illustrates an embodiment of a scoring update method 1900.

FIG. 20 illustrates an embodiment of a timed update method 2000.

FIG. 21 illustrates an embodiment of a detected update method 2100.

FIG. 22 illustrates a system 2200 in accordance with one embodiment.

### DETAILED DESCRIPTION

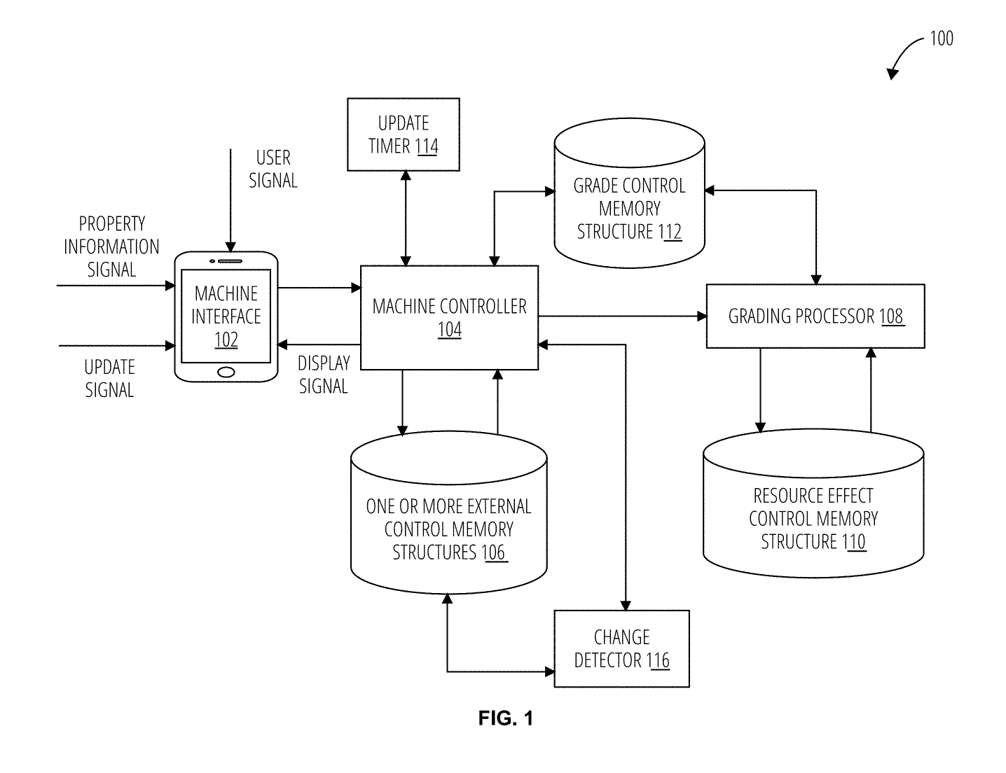

Referring to FIG. 1, a property grading system 100 comprises a machine interface 102, a machine controller 104, a one or more external control memory structures 106, a grading processor 108, a resource effect control memory structure 110, a grade control memory structure 112, an update timer 114, and a change detector 116.

The machine interface 102 receives a property information signal, an update signal, a user signal, and a display signal (or an updated display signal). The property information signal, the update signal, and the user signal may be input to the machine interface 102 via input devices configured to receive audio, text, haptic inputs, files, etc. The machine interface 102 receives the display signal and transforms the display signal into a visual display. The machine interface 102 displays information associated with the grade control signal determined by the property grading system 100, as well as information associated with the external grading resources. The machine interface 102 may transform the property information signal and the update signal, and send those input signals to the machine controller 104. The machine interface 102 may display one or more activation controls on the machine display to receive the input. The machine interface 102 may display the one or more activation controls in response to receiving a location, such as an input of a zip code, a control signal from a device including GPS coordinates, detection of a geofence, etc. The machine interface 102 may also display one or more display activation controls based on the display signal received, the one or more display activation controls operable to receive an update signal.

The machine controller 104 receives the inputs (the property information signal, the update signal, and the user signal) from the machine interface 102, the external grading resources from the one or more external control memory structures 106, an update signal from the update timer 114, a grade control signal from the grade control memory structure 112, and a detected change signal from the change detector 116. The machine controller 104 may utilize the property information signal to determine the external grading resources for evaluation. The machine controller 104 may also determine whether the property information signal has been associated with the grade control memory structure 112. The machine controller 104 also determines an update time period. The machine controller 104 may utilize machine-based learning techniques to determine effects of the external grading resources and update those one or more resource effects in the resource effect control memory structure 110. The one or more resource effects may also be determined by a location associated with the property information signal. The machine controller 104 may also determine update time periods for each of the one or more external control memory structures 106. This may be based on collected information regarding whether a resource control signal prompted by a control signal from the update timer 114 results in an update to the grade control signal. The machine controller 104 converts the grade control signal to the display signal and sends the display signal (or updated display signal) to the machine interface 102, a resource control signal to the one or more external control memory structures 106, a grade control signal request signal to the grade control memory structure 112, an update time period signal and a grade time stamp to the update timer 114, and a control signal to the change detector 116. The display signal may operate the machine interface 102 to display one or more display activation controls configured to receive an update signal associated with one or more of the external grading resources. For example, one of the one or more external grading resources may not be present in the one or more external control memory structures 106. One of the one or more display activation controls may enable the external grading resource to be input to the machine interface 102, which may send the external grading resource as an update signal.

The one or more external control memory structures 106 receives a resource control signal from the machine controller 104 and a control signal from the change detector 116. The one or more external control memory structures 106 comprises external grading resources, which may be sent to the machine controller 104 in response to a resource control signal. The one or more external control memory structures 106 may also send a control signal to the change detector 116 in response to an alteration of external grading resources in the one or more external control memory structures 106 for which the change detector 116 has sent a control signal to detect a change.

The grading processor 108 receives external grading resources from the machine controller 104, one or more resource effects from the resource effect control memory structure 110, and previously stored grade control signals from the grade control memory structure 112. In response to receiving the external grading resources from the machine controller 104, the grading processor 108 may send a control signal to retrieve stored grade control signals in the grade control memory structure 112. The grading processor 108 also sends a control signal to the resource effect control memory structure 110 to retrieve the one or more resource effects from the resource effect control memory structure 110 associated with the external grading resources received from the machine controller 104. The grading processor 108 transforms the one or more resource effects associated with the external grading resources into a grade control signal. The one or more resource effects may be valued on a grading scale (e.g., A, B, C, etc.) or numerical ranking to determine the relative effect of one of the external grading resources to another. The grading processor 108 may determine the grade control signal based on the highest relative effect, the lowest relative effect, or an average effect (which may be a weighted average). The grade control signal may also be altered based on the number of the one or more resource effects at a particular ranking. The grade control signal may be expressed as a grading scale (e.g., A, B, C, etc.) or numerical ranking when displayed. The grading processor 108 sends the grade control signal to the grade control memory structure 112. These processes may be performed in accordance with Listing (i).

The resource effect control memory structure 110 receives a control signal from the grading processor 108 to send the one or more resource effects associated with the external grading resources received by the grading processor 108. The resource effect control memory structure 110 determines the one or more resource effects to be sent to the grading processor 108 and sends those one or more resource effects to the grading processor 108.

The grade control memory structure 112 may receive control signals to send a grade control signal to either the machine controller 104 or the grading processor 108. The grade control memory structure 112 also receives a grade control signal to store. The grade control signal may be associated with a property information signal. The grade control memory structure 112 may send a grade control signal to the machine controller 104 or the grading processor 108 in response to a request, the specific grade control signal sent being the grade control signal associated with a property information signal. The grade control memory structure 112 may also associate a grade time stamp with the grade control signal, the grade time stamp being a time associated with when the grade control signal has been determined or updated. The grade time stamp may be sent to the machine controller 104. The grade control memory structure 112 may associate a user signal with credential, the credential being associated with a property information signal.

The update timer 114 may receive an update time period signal and the grade time stamp from the machine controller 104. The update timer 114 determines whether an update time period has elapsed based on the grade time stamp and the update time period signal, the update time period signal comprising information regarding the amount of time until a control signal is sent to the machine controller 104. The update timer 114 may utilize an initial time indicator, such as the grade time stamp, and a counter to determine whether the update time period has elapsed. When the update time period has elapsed, the update timer 114 sends a control signal to the machine controller 104, the control signal may comprise instructions for the machine controller 104 to send a resource control signal to receive external grading resources from the one or more external control memory structures 106. An update time period signal may have the same or different update time periods associated with the each of the one or more external control memory structures 106 and each external grading resources stored within the one or more external control memory structures 106. These processes may be performed in accordance with Listing (ii).

The change detector 116 receives a control signal from the machine controller 104 and a control signal from the one or more external control memory structures 106. In response to the control signal from the machine controller 104, the change detector 116 determine when a change occurs to the one or more external control memory structures 106. The control signal may instruct the change detector 116 to detect changes to one of more of the one or more external control memory structures 106. In response receive a control signal from one or more of the one or more external control memory structures 106, the change detector 116 sends a control signal to the machine controller 104 to request the associated external grading resources from the one or more external control memory structures 106. These processes may be performed in accordance with Listing (iii).

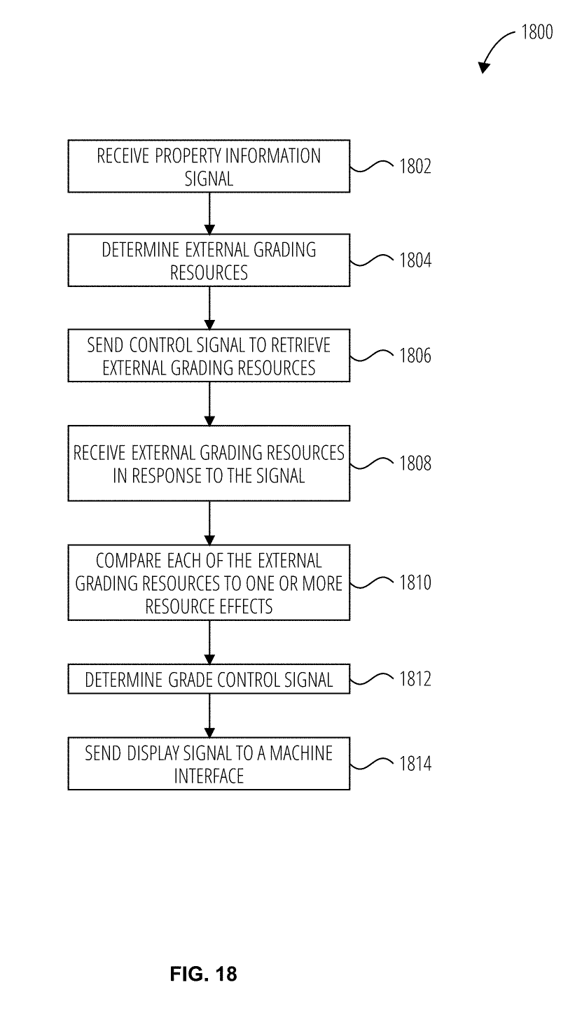

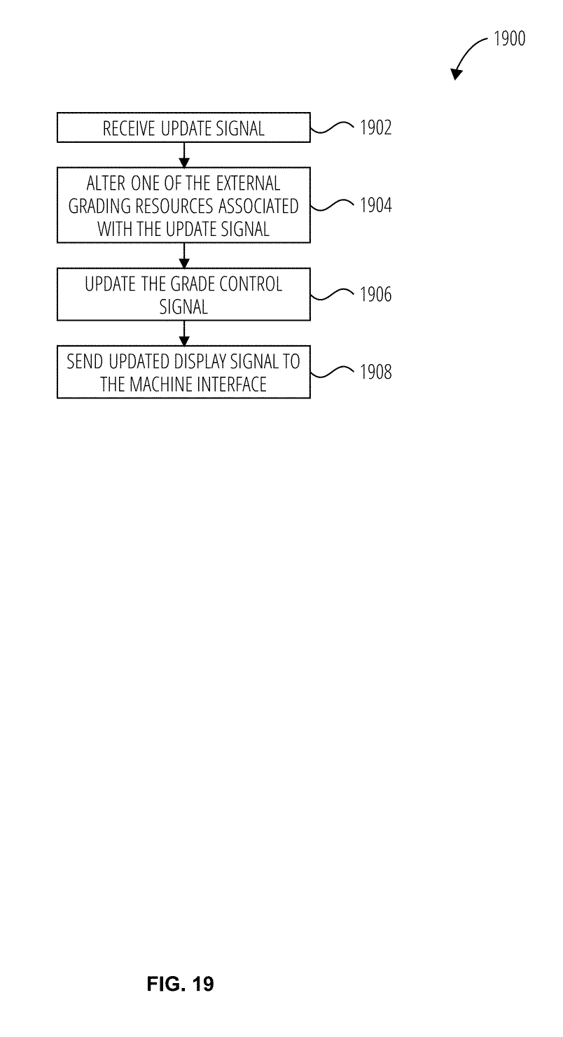

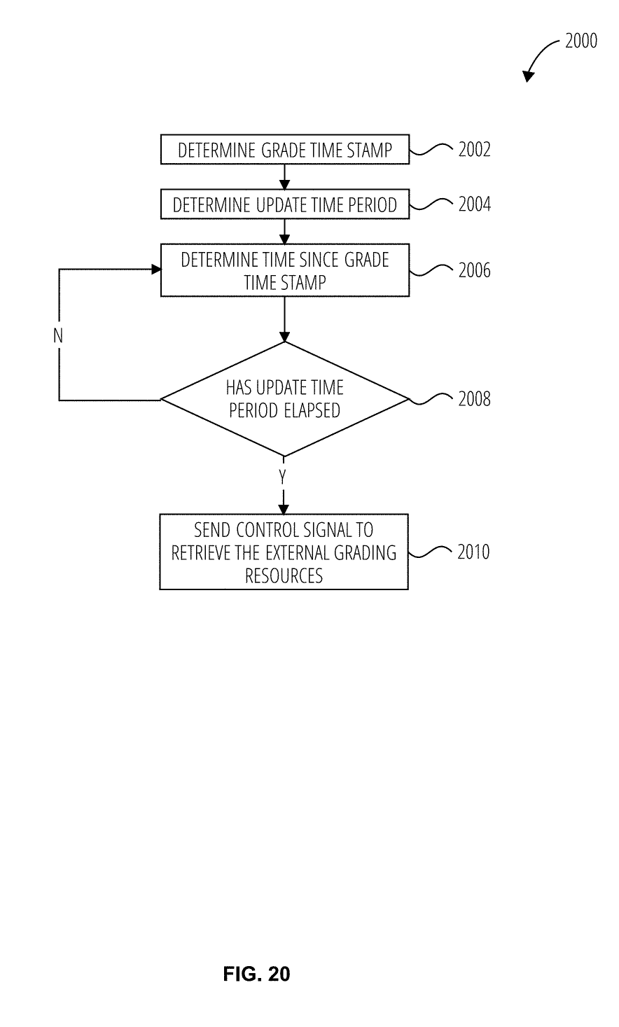

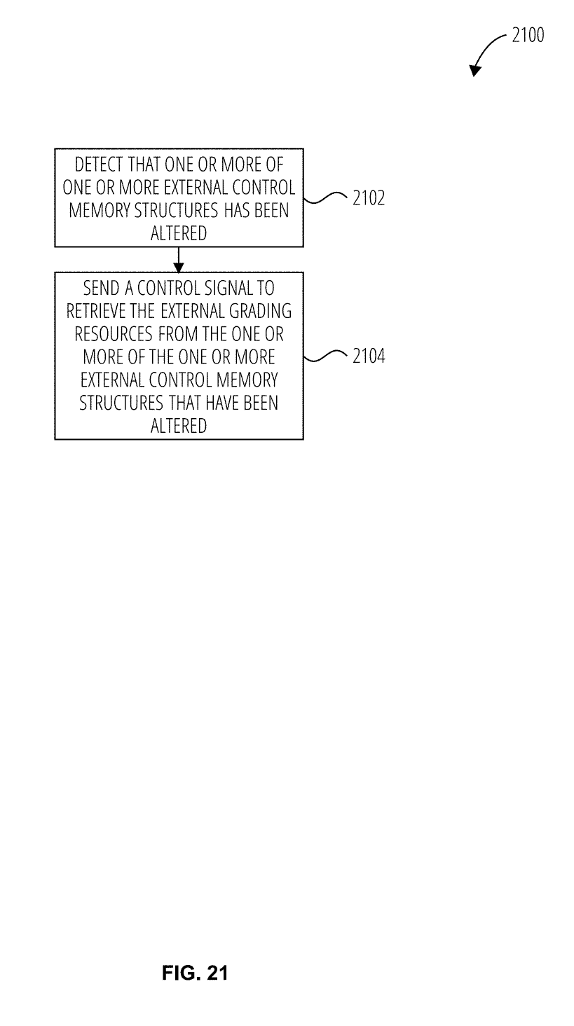

The property grading system 100 may be operated in accordance with FIG. 18, FIG. 19, FIG. 20, and FIG. 21.

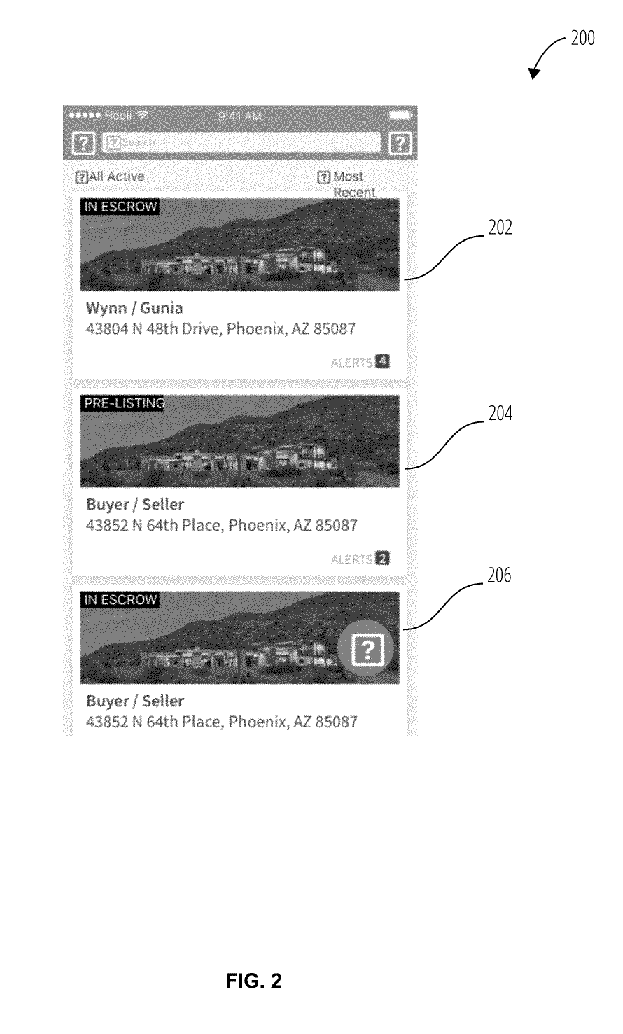

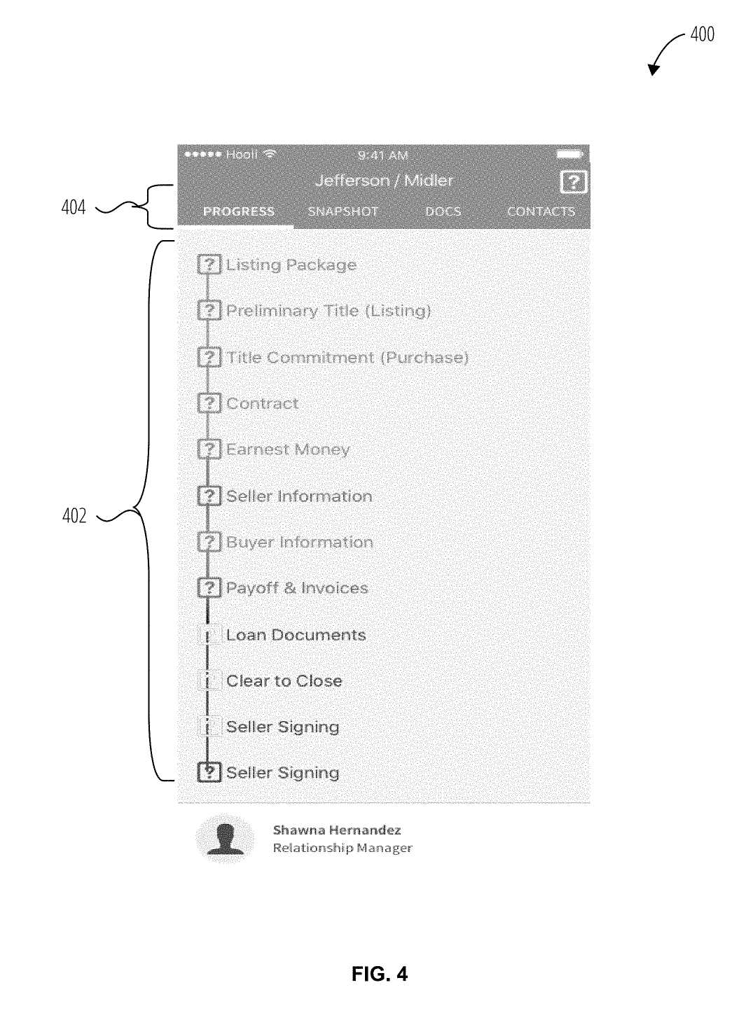

Referring to FIG. 2, a machine interface display 200 comprises a first property information signal activation control 202, a second property information signal activation control 204, and a third property information signal activation control 206 oriented in a mobile-based browser display configuration. The machine interface display 200 may be displayed on the machine interface 102. Each property information signal activation control may be associated with a property information signal. An input device may be utilized to select a property information signal activation control. Selecting one of the property information signal activation controls sends the associated property information signal to the machine controller. Selecting one of the property information signal activation controls may also activate further controls on the machine interface display 200. The machine interface display 200 may display the properties associated with a user account via a user signal. The property information signal activation controls may alter the display to an interface, such as the interface depicted in FIG. 4.

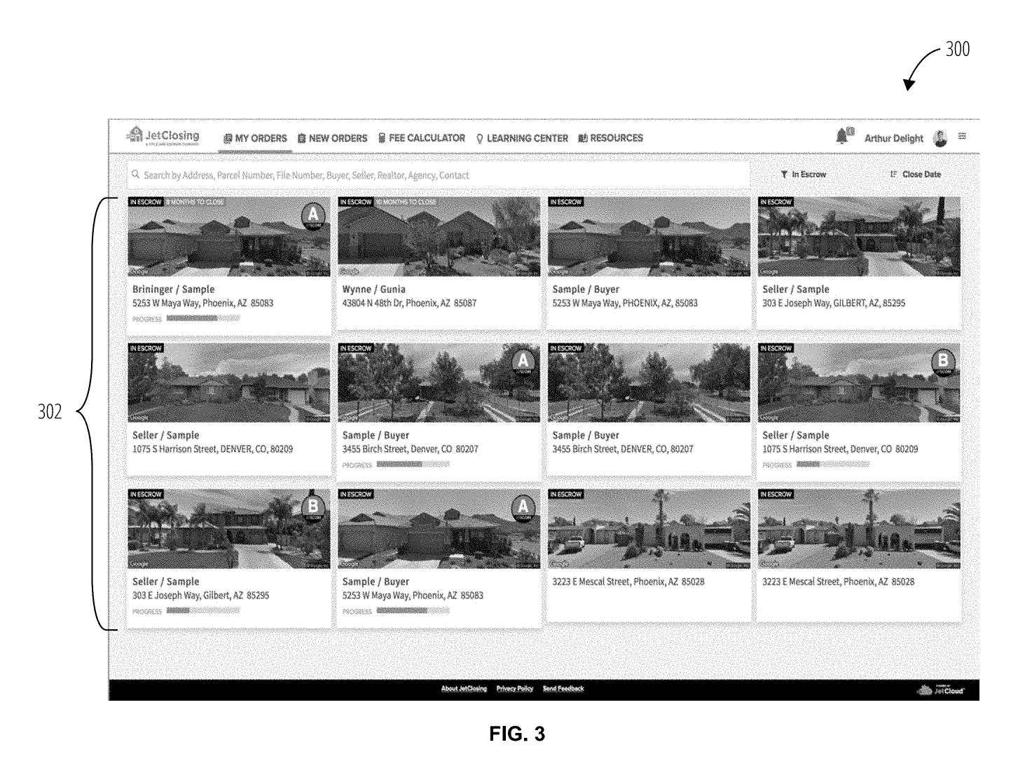

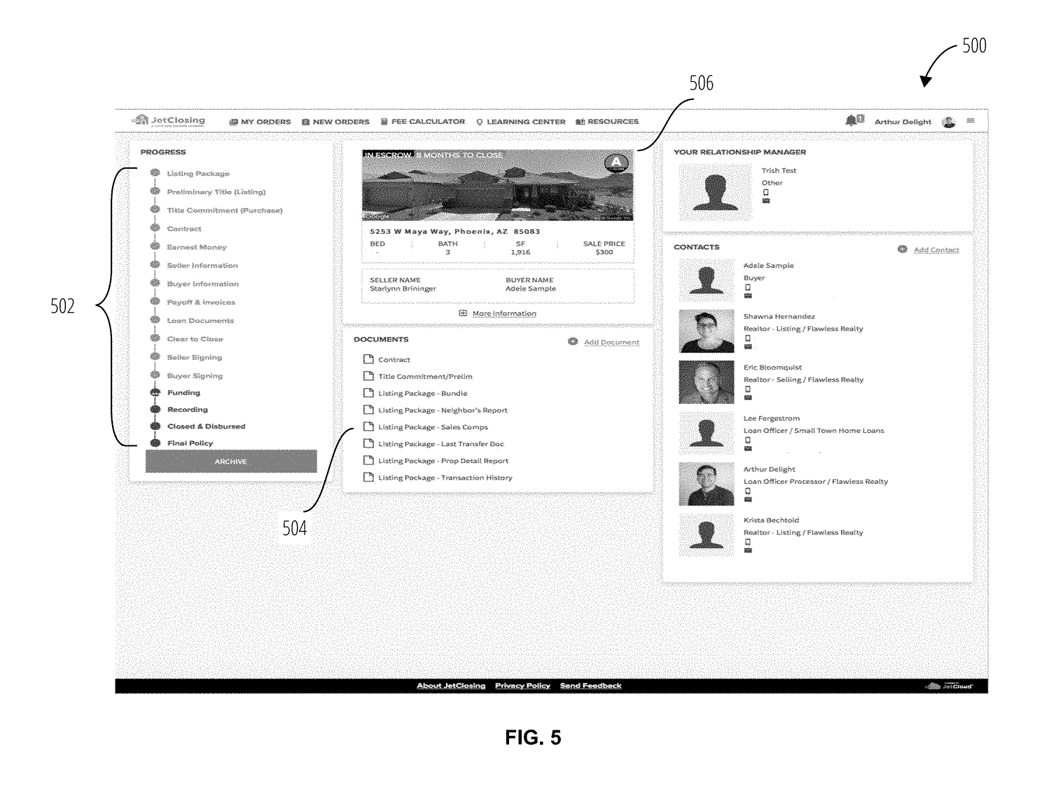

Referring to FIG. 3, a machine interface display 300 comprises one or more property information signal activation controls 302 oriented in a web-based browser display configuration. The machine interface display 300 may be displayed on the machine interface 102. Each of the property information signal activation controls may be associated with a property information signal. An input device may be utilized to select a property information signal activation controls. Selecting one of the property information signal activation controls sends the associated property information signal to the machine controller. Selecting one of the property information signal activation controls may also activate further controls on the machine interface display 300. The machine interface display 300 may display the properties associated with a user account via a user signal. The property information signal activation controls 302 may alter the display to an interface, such as the interface depicted in FIG. 5.

Referring to FIG. 4, a machine interface display 400 comprises display activation controls 402 and view activation controls 404 oriented in a mobile-based browser display configuration. The machine interface display 400 may be displayed on the machine interface 102.

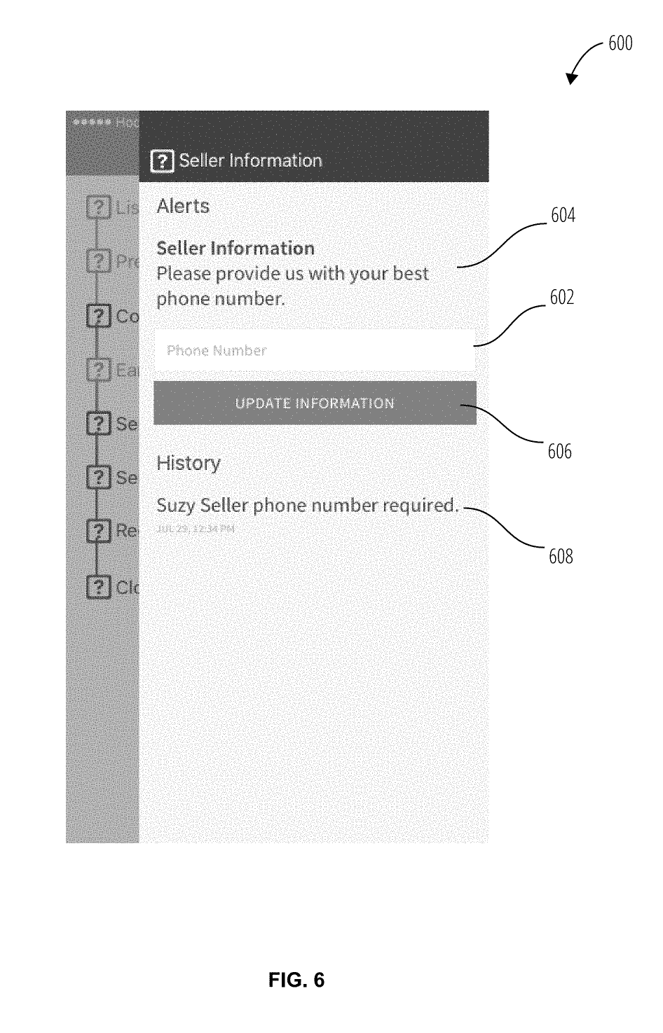

The display activation controls 402 provide an indication of status of the major milestones (alternatively, “bubbles”) on a specific real estate closing associated with a property information signal. The view activation controls 404 may be selected to alter the display to view further information. An input device may be utilized to select one of the display activation controls 402. In response more data may surface beneath offering more details as to ordered, received, needed states of bubble data. If the bubble is not applicable to a certain product, it will not be surfaced to the user. The displayed “bubbles” may be determined by the machine controller 104 and sent to the machine interface 102 via a display signal. The machine controller 104 may utilize the grade control signal in the grade control memory structure 112 associated with the property information signal and the one or more resource effects in the resource effect control memory structure 110 to determine the “bubbles” displayed. Each of the display activation controls 402 may have a display indicator associated with it. For example, the green question marks may mean completed, red question marks may mean the user needs to provide information to the company for further processing, and the black question marks may mean in progress. Some display activation controls 402, such as those with a red question mark, may display an interface to receive an update signal, as depicted in FIG. 6.

Referring to FIG. 5, a machine interface display 500 comprises display activation controls 502, a document list 504, and a property snapshot 506 oriented in a web-based browser display configuration. The machine interface display 500 may be displayed on the machine interface 102.

The display activation controls 502 provide an indication of status of the major milestones (alternatively, “bubbles”) on a specific real estate closing associated with a property information signal. The document list 504 may comprise activators to add, view, and edit documents associated with a property information signal. The property snapshot 506 may display information associated with the property information signal.

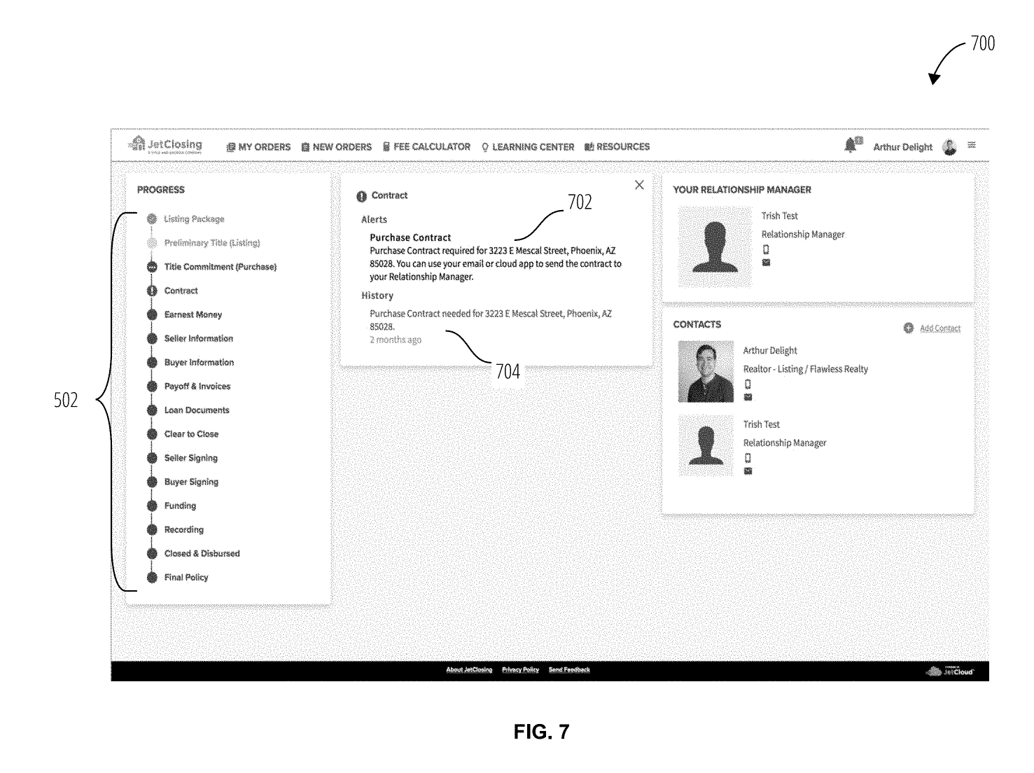

An input device may be utilized to select one of the display activation controls 502. In response more data may surface beneath offering more details as to ordered, received, needed states of bubble data. If the bubble is not applicable to a certain product, it will not be surfaced to the user. The displayed “bubbles” may be determined by the machine controller 104 and sent to the machine interface 102 via a display signal. The machine controller 104 may utilize the grade control signal in the grade control memory structure 112 associated with the property information signal and the one or more resource effects in the resource effect control memory structure 110 to determine the “bubbles” displayed. Each of the display activation controls 502 may have a display indicator associated with it. For example, the green check marks may mean completed, red exclamation points may mean the user needs to provide information to the company for further processing, and the black ellipses may mean in progress. Some display activation controls 502, such as those with a red exclamation point, may display an interface to receive an update signal, as depicted in FIG. 7.

Referring to FIG. 6, the machine interface display 600 comprises an update signal receiver 602, an update signal descriptor 604, an update signal activation control 606, and an update signal history 608 oriented in a mobile-based browser display configuration. The machine interface display 600 may slide into the display of a machine interface from one or more edges of the machine interface or have an origin point from the one of the display activation controls 402 activated. The machine interface display 600 may then overlay the previous machine interface display. The machine interface display 600 may also partially overly the previous machine interface display, such as up to 10%, up to 20%, up to 30%, up to 40%, up to 50%, up to 60%, up to 70%, up to 80%, or up to 90%. The machine interface display 600 may be configured based on the display signal received by the machine interface from the machine controller.

The update signal receiver 602 may receive an update signal. The update signal may include audio, text, haptic inputs, files, etc. The update signal descriptor 604 may comprise a description of the type of update signal to be entered into the update signal receiver 602. The update signal activation control 606 may be utilized to have the machine interface 102 send the update signal to the machine controller 104. The update signal activation control 606 may receive audio, text, haptic inputs, etc. to operate. The update signal history 608 may display a list of previous actions associated with the update signal, as well as further information, such as date, time, and user of the action related to the update signal.

Referring to FIG. 7, a machine interface display 700 comprises display activation controls 502, an update signal descriptor 702, and an update signal history 704 oriented in a web-based browser display configuration. The machine interface display 700 may alter the display of a machine interface when one of the display activation controls 502 is activated. The update signal descriptor 702 may comprise a description of the type of update signal associated with the selected on of the display activation controls 502. The update signal history 704 may display a list of previous actions associated with the update signal, as well as further information, such as date, time, and user of the action related to the update signal.

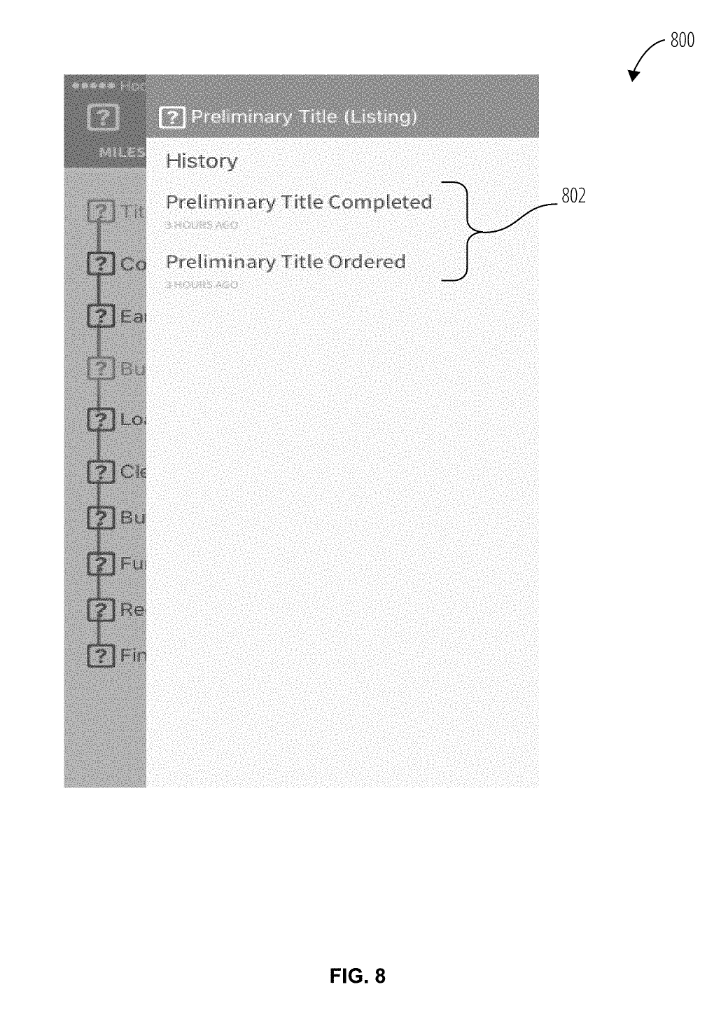

Referring to FIG. 8, a machine interface display 800 comprises a display activation control history display 802 oriented in a mobile-based browser display configuration. The machine interface display 800 may slide into the display of a machine interface from one or more edges of the machine interface or have an origin point from the one of the display activation controls 402 activated. The machine interface display 800 may then overlay the previous machine interface display. The machine interface display 800 may also partially overly the previous machine interface display, such as up to 10%, up to 20%, up to 30%, up to 40%, up to 50%, up to 60%, up to 70%, up to 80%, or up to 90%. The display activation control history display 802 may be displayed based on the display signal received by the machine interface from the machine controller. The display activation control history display 802 may depict a list of previous actions associated with the selected one of the display activation controls 402, as well as further information, such as date, time, and user of the action.

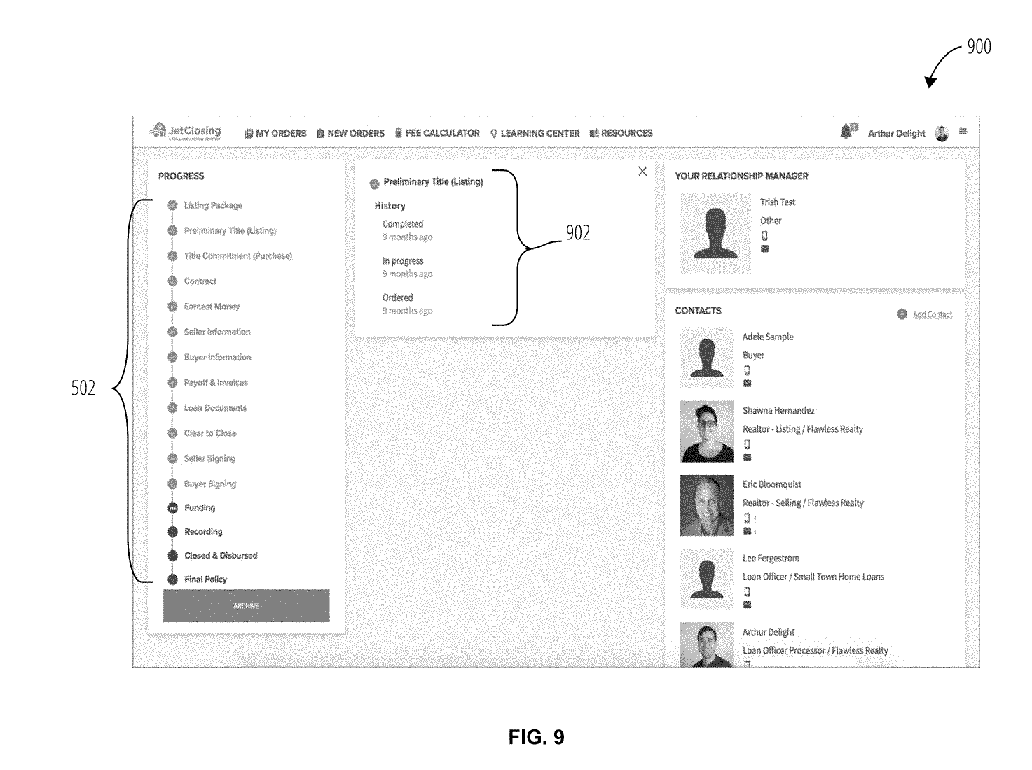

Referring to FIG. 9, a machine interface display 900 comprises display activation controls 502 and a display activation control history display 902 oriented in a web-based browser display configuration. The machine interface display 900 may alter the display of a machine interface when one of the display activation controls 502 is activated. The display activation control history display 902 may be displayed based on the display signal received by the machine interface from the machine controller. The display activation control history display 902 may depict a list of previous actions associated with the selected one of the display activation controls 502, as well as further information, such as date, time, and user of the action.

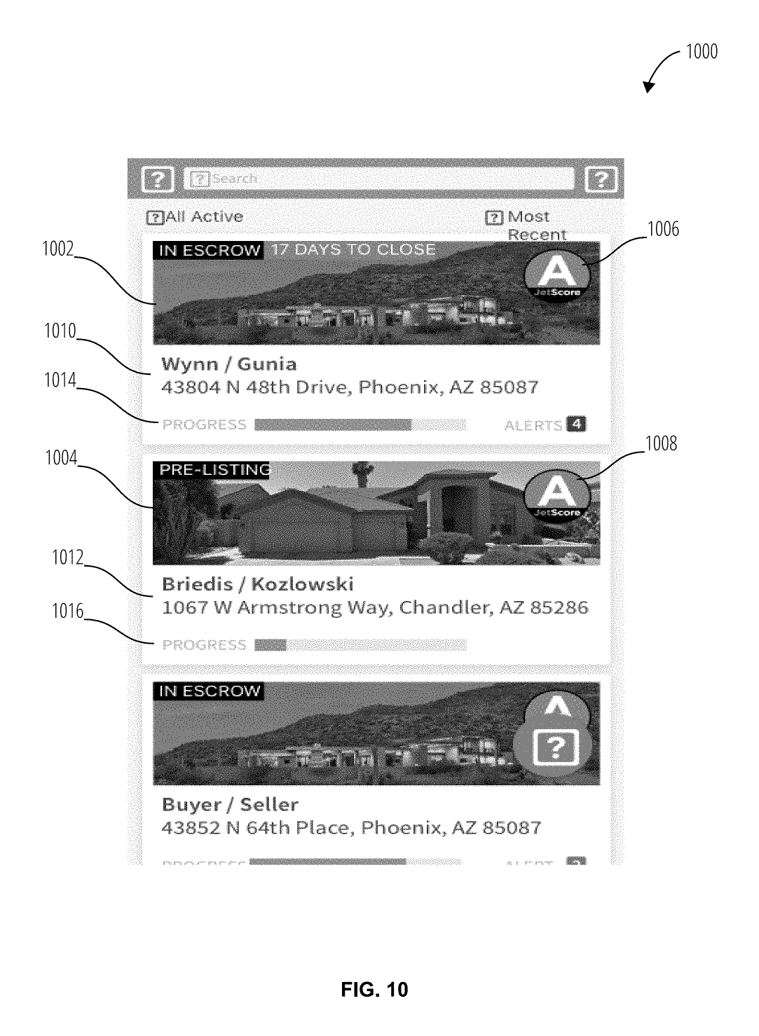

Referring to FIG. 10, a machine interface display 1000 comprises a first property information signal activation control 1002, a second property information signal activation control 1004, a first grade control signal indicator 1006, a second grade control signal indicator 1008, a first property information signal indicator 1010, a second property information signal indicator 1012, a first progress indicator 1014, and a second progress indicator 1016 oriented in a mobile-based browser display configuration. The machine interface display 1000 may be displayed on the machine interface 102.

Each property information signal activation control may be associated with a property information signal. An input device may be utilized to select a property information signal activator. Selecting one of the property information signal activator sends the associated property information signal to the machine controller. Selecting one of the property information signal property information signal activation control may also activate further controls on the machine interface display 1000. For example, the machine interface display 400 may be displayed for the selected property information signal activation control.

The machine interface display 1000 may display the properties associated with a user account via a user signal. As depicted, the first property information signal activation control 1002 is associated with the first grade control signal indicator 1006, the first property information signal indicator 1010, and the first progress indicator 1014. The first grade control signal indicator 1006, the first property information signal indicator 1010, and the first progress indicator 1014 may be associated with a property information signal in a grade control memory structure and displayed as a result of the associated display signal interacting with the machine interface 102. Furthermore, the second property information signal activation control 1004 is associated with the second grade control signal indicator 1008, the second property information signal indicator 1012, and the second progress indicator 1016. The second grade control signal indicator 1008, the second property information signal indicator 1012, and the second progress indicator 1016 may be associated in the grade control memory structure and displayed as a result of the associated display signal interacting with the machine interface 102.

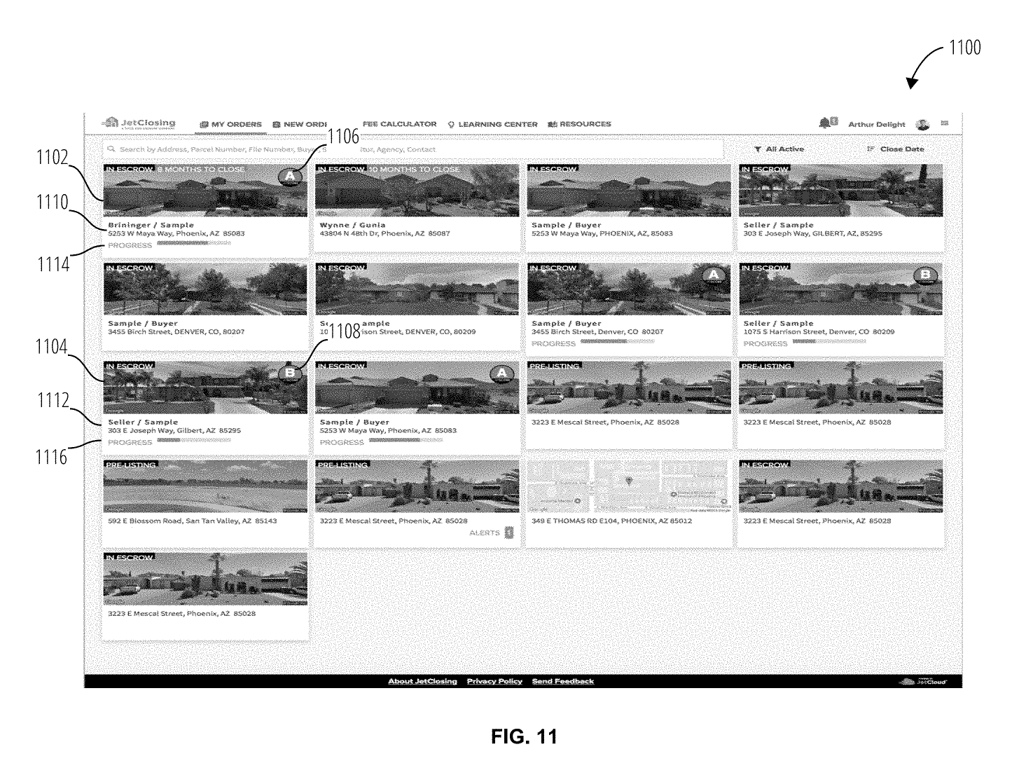

Referring to FIG. 11, a machine interface display 1100 comprises a first property information signal activation control 1102, a second property information signal activation control 1104, a first grade control signal indicator 1106, a second grade control signal indicator 1108, a first property information signal indicator 1110, a second property information signal indicator 1112, a first progress indicator 1114, and a second progress indicator 1116 oriented in a web-based browser display configuration. The machine interface display 1100 may be displayed on the machine interface 102.

Each property information signal property information signal activation control may be associated with a property information signal. An input device may be utilized to select a property information signal property information signal activation control. Selecting one of the property information signal property information signal activation control sends the associated property information signal to the machine controller. Selecting one of the property information signal activator may also activate further controls on the machine interface display 1100. For example, the machine interface display 500 may be displayed for the selected property information signal activation control.

The machine interface display 1100 may display the properties associated with a user account via a user signal. As depicted, the first property information signal activation control 1102 is associated with the first grade control signal indicator 1106, the first property information signal indicator 1110, and the first progress indicator 1114. The first grade control signal indicator 1106, the first property information signal indicator 1110, and the first progress indicator 1114 may be associated with a property information signal in a grade control memory structure and displayed as a result of the associated display signal interacting with the machine interface 102. Furthermore, the second property information signal activation control 1104 is associated with the second grade control signal indicator 1108, the second property information signal indicator 1112, and the second progress indicator 1116. The second grade control signal indicator 1108, the second property information signal indicator 1112, and the second progress indicator 1116 may be associated in the grade control memory structure and displayed as a result of the associated display signal interacting with the machine interface 102.

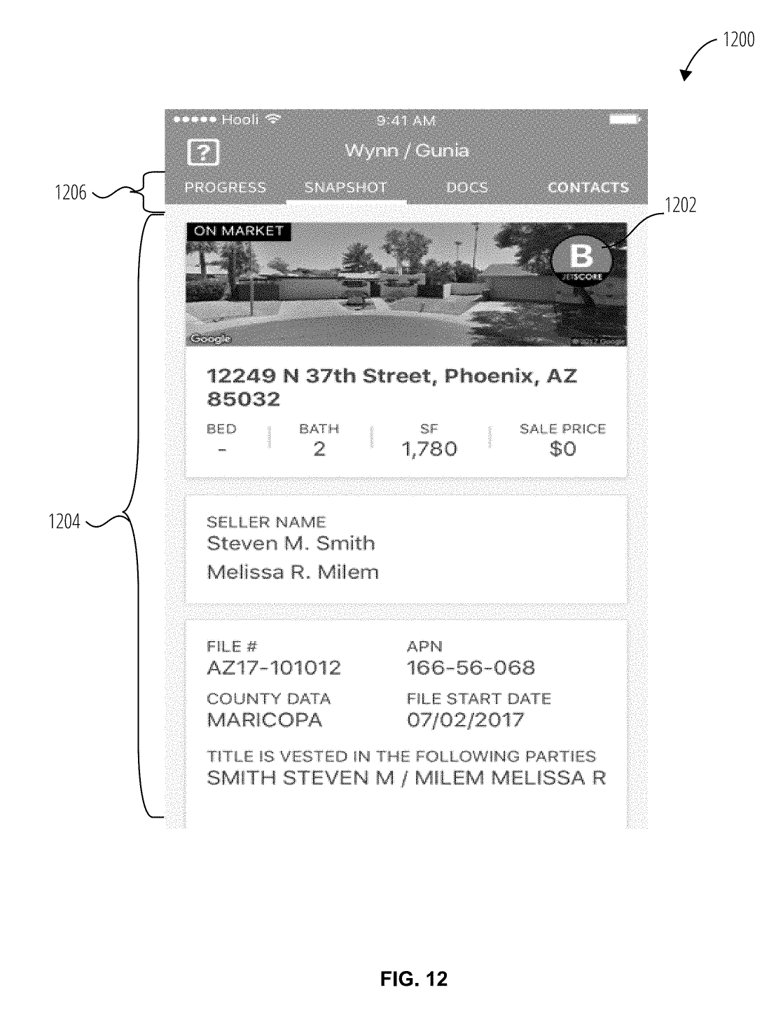

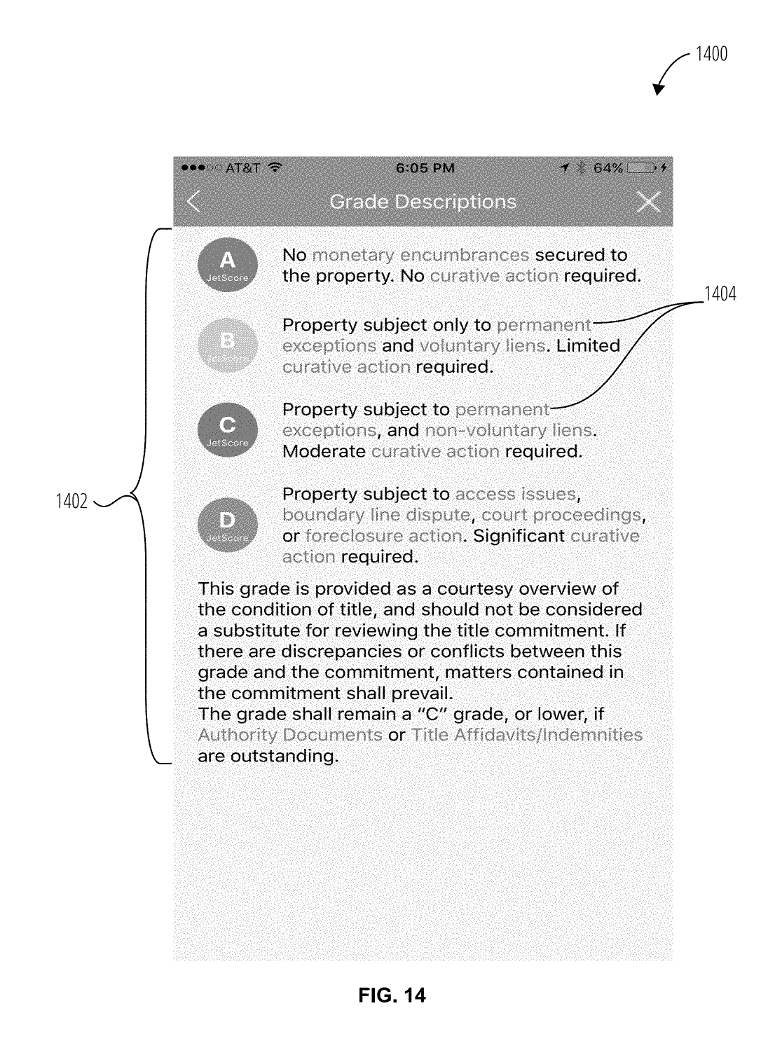

Referring to FIG. 12, the machine interface display 1200 comprises a grade control signal indicator 1202, an enhanced property information signal display 1204, and a view activation controls 1206 oriented in a mobile-based browser display configuration. The grade control signal indicator 1202 may be associated with a property information signal in a grade control memory structure and displayed as a result of the associated display signal interacting with the machine interface 102. The grade control signal indicator 1202 may further receive an input, the input activating a further display which may appear on the display via a fly-out surface(s). The further display is depicted in FIG. 14. The enhanced property information signal display 1204 may be displayed as a result of the activation of a property information signal activation control via the associated display signal interacting with the machine interface 102. The additional information may be stored in the grade control memory structure. The view activation controls 1206 may be selected to alter the display to view further information.

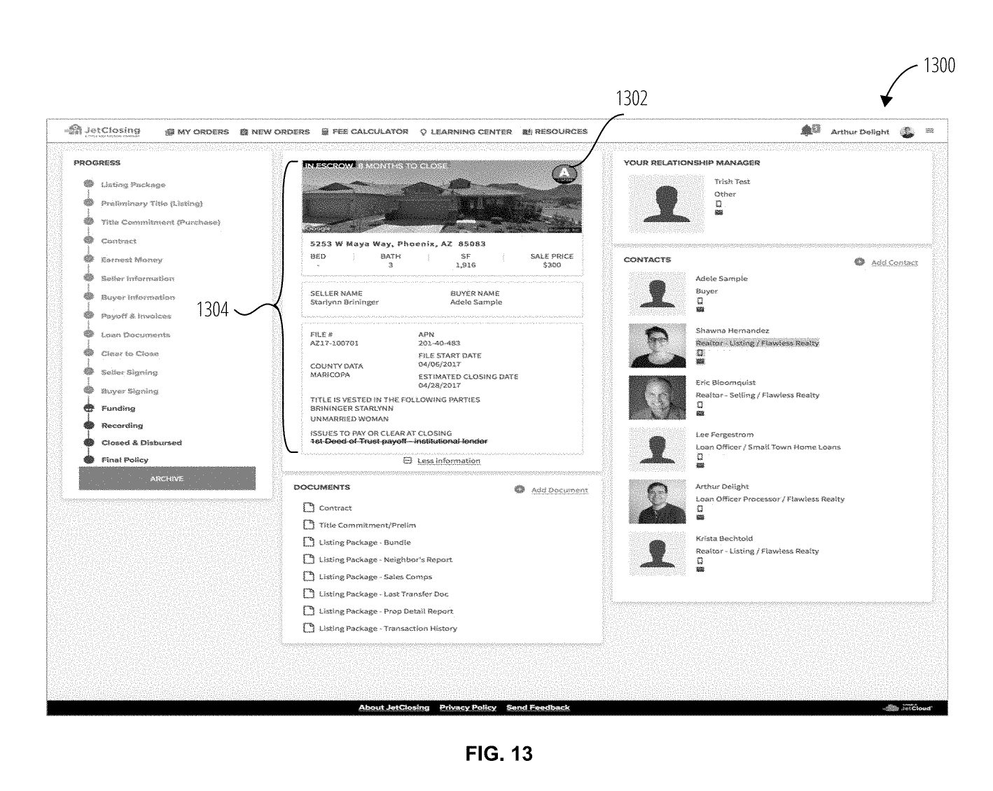

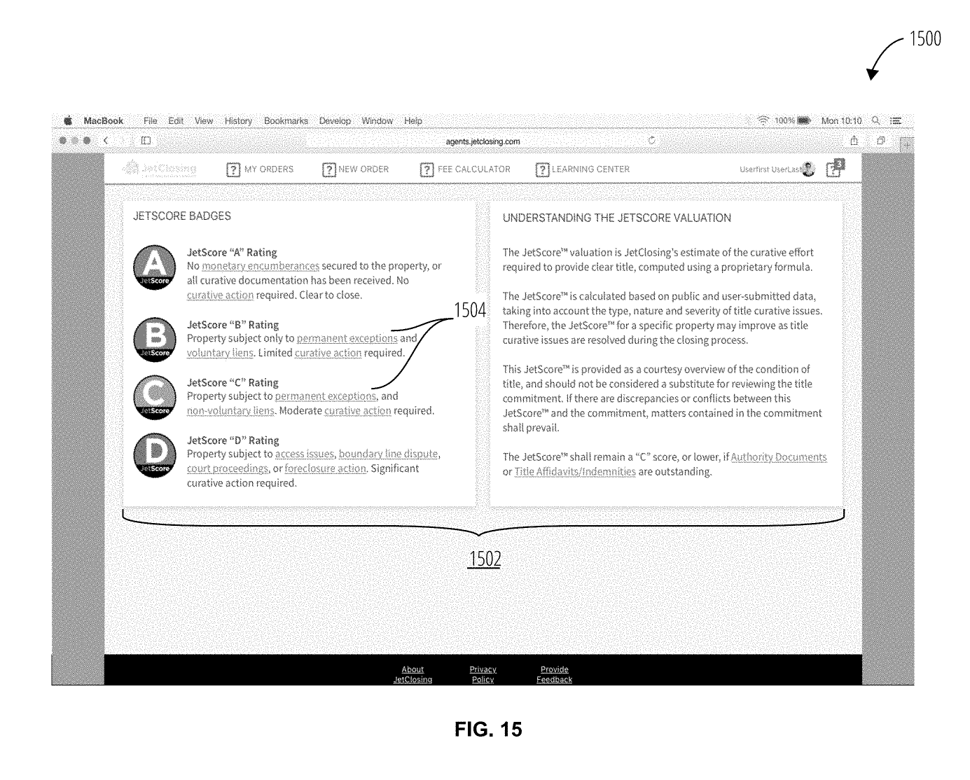

Referring to FIG. 13, the machine interface display 1300 comprises a grade control signal indicator 1302 and an enhanced property information signal display 1304 oriented in a web-based browser display configuration. The grade control signal indicator 1302 may be associated with a property information signal in a grade control memory structure and displayed as a result of the associated display signal interacting with the machine interface 102. The grade control signal indicator 1302 may further receive an input, the input activating a further display which may appear on the display via a fly-out surface(s). The further display is depicted in FIG. 15. The enhanced property information signal display 1304 may be displayed as a result of the activation of a property information signal activation control via the associated display signal interacting with the machine interface 102. The additional information may be stored in the grade control memory structure.

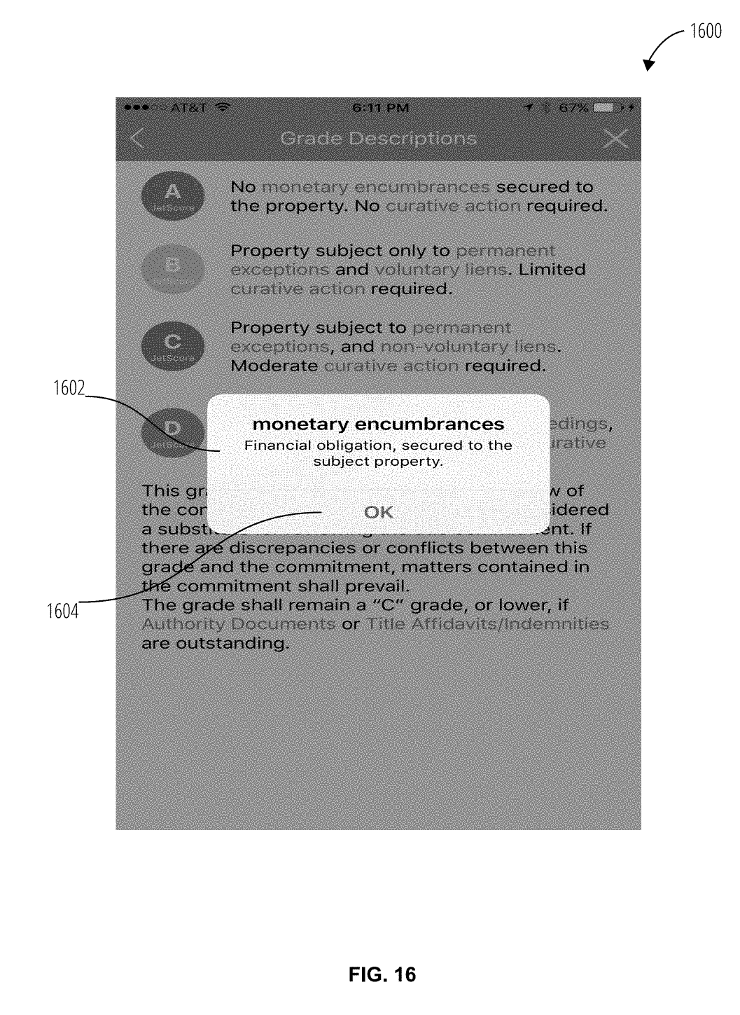

The machine interface display 1400 comprises a grade control signal description 1402 and one or more definition activation controls 1404 oriented in a mobile-based browser display configuration. The grade control signal description 1402 may display further information for each grade control signal. The one or more definition activation controls 1404 may receive an input and in response alter the machine display to display further information regarding the selected definition of the one or more definition activation controls 1404. The one or more definition activation controls 1404 may be hyperlinks that activate a pop up display with the definition of the selected definition of the one or more definition activation controls 1404, such as that depicted in FIG. 16. The further information may be stored on a local device, such as the device comprising the machine interface. The information may also be stored in the resource effect control memory structure and retrieved via the input signal.

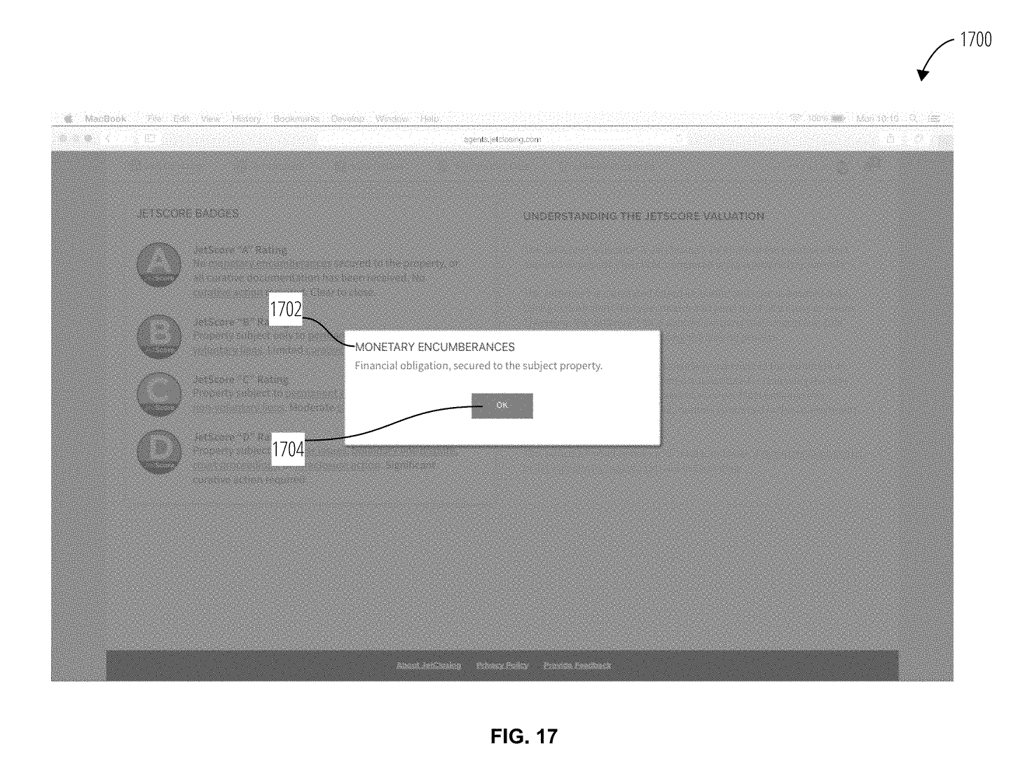

The machine interface display 1500 comprises a grade control signal description 1502 and one or more definition activation controls 1504 oriented in a web-based browser display configuration. The grade control signal description 1502 may display further information for each grade control signal. The one or more definition activation controls 1504 may receive an input and in response alter the machine display to display further information regarding the selected definition of the one or more definition activation controls 1504. The one or more definition activation controls 1504 may be hyperlinks that activate a pop up display with the definition of the selected definition of the one or more definition activation controls 1504, such as that depicted in FIG. 17. The further information may be stored on a local device, such as the device comprising the machine interface. The information may also be stored in the resource effect control memory structure and retrieved via the input signal.

Referring to FIG. 16, the machine interface display 1600 comprises a selected definition display 1602 and a selected definition de-activation control 1604 oriented in a mobile-based browser display configuration. The selected definition display 1602 may be displayed in response to the activation of one of the one or more definition activation controls 1404. The content may be stored locally or in the resource effect control memory structure. The selected definition de-activation control 1604 may receive an input and in response alter the machine display to return to the machine interface display 1400.

Referring to FIG. 17, the machine interface display 1700 comprises a selected definition display 1702 and a selected definition de-activation control 1704 oriented in a web-based browser display configuration. The selected definition display 1702 may be displayed in response to the activation of one of the one or more definition activation controls 1504. The content may be stored locally or in the resource effect control memory structure. The selected definition de-activation control 1704 may receive an input and in response alter the machine display to return to the machine interface display 1500.

Referring to FIG. 18, the scoring method 1800 comprises receiving a property information signal (block 1802) The property information signal may comprise information for identifying a property, such as an address. The external grading resources are determined (block 1804). The external grading resources may be a predetermined list, may be determined dynamically based on previously received property information signals, or may be selected from the predetermined list based on factors such as location or determined trends. A control signal is sent to retrieve external grading resources (block 1806). The external grading resources may be retrieved from the one or more external control memory structures. The external grading resources are retrieved in response to the signal (block 1808). Each of the external grading resources is compared to one or more resource effects (block 1810). A grade control signal is determined (block 1812). In some embodiments, the grade control signal may be stored. A display signal is sent to a machine interface (block 1814). The display signal comprise instructions to display the grade control signal. The display signal may also comprise instructions to alter the machine interface to indicate the results of the comparison, as well as actions that may alter the comparison. The machine interface may be further altered to enable those actions to be performed via the machine interface.

Each of the external grading resources may be associated with one or more resource effects, which may be stored in a resource effect control memory structure. The external grading resources may include, but is not limited to: Lack of a right of access to and from the land; Defective Acknowledgment in Deed; Adverse Claim Disclosed; Proposed Seller or Borrower Does Not Have Title; Lacks Legal Capacity to Hold Title; Farm Credit System Institution Foreclosure of Deed of Trust; Farmland Foreclosure by or Deed in Lieu to Secretary of Agriculture; Farmland Homestead Property Acquired by Secretary of Agriculture; Bankruptcy Applies—Require Bankruptcy Documentation; Bankruptcy—Lift of Stay; Boundary Line Conflict—Requires Boundary Line; Condominium Assessments; Approval of Sale; Certificate of Completion; Proof of Payment of Assessments; Recorded Assessment Lien—Secure Release; First Refusal; Record Certified Copy; Authority of Church to Sell or Mortgage; Conveyance to Trustees of Church; Authority of Corporation; Corporate Charter Has Been Forfeited—Require; Corporate Restructure; Alien Corporation Authority; Corporation was Dissolved; Compliance with ARS Title 10; Corporation Revoked—Less than 6 Months.; Proof of Forfeiture; Insuring the Contract—Review a Copy; Possible Outstanding Contracts; Requirement of Seller Consent to Transaction; Affidavit of Completion of Forfeiture; Review of Forfeiture Proceedings; Notice of Reinstatement; Tenancy by Entirety—Survivorship; Tenancy—Survivorship; Pending Administration—Require Court Order; Require Administration and Authorization; Determine of Heirship if No Administration; Proof of Death—Joint Tenancy or Tenants by Entireties; Estate and Death Taxes; Recordation of Affidavit of Succession to Real Property; Record Certificate of Purchase—State Land; Record Certificate of Purchase with Assignment; Adequacy of the Deed in Lieu of Foreclosure; Release by Noninstituional Lender; Payoff of Credit Line; Foreclosure; Substantial Delay in Recording; Recording After the Grantor's Death; Defective Description; Record Copy of Divorce; Review Copy of Divorce; Require Deed; Release of Divorce Lien; Pending Divorce; Alimony Judgment; Child Support Order; Parties in Possession (1-4 Family); Parties in Possession (Commercial or Agricultural); Easements and Survey Matters; Easements and Survey Matters (Preferred Survey); Mechanic's Liens; Taxes and Assessments; Gift Tax Lien, if any; Federal Tax Lien—Nonjudicial Foreclosure; Require Release of Lien; Require Gap Indemnity; Satisfactory Evidence Required by Company; Court Approval of Transaction; Hospital Hill-Burton Funds; Proof of Death of Joint Tenant by Affidavit; Search of Names; Release of Judgments; Attachment; Writ of Execution; Proof that Lease Exists; Proof that Lease Ended; Insuring a New Lease; Application to Assign Lease; Record State Lease; Assignment of State Lease; Record Assigned State Lease; Landlord's Estoppel Affidavit; Life Estate—Proof Ended or Joinder; Release of Withdrawal of Lis Pendens and Suit; Require Suit Dismissal; Suit Not Examined; Persons Not Made Parties; Persons Served by Publication; Limited Liability Company Transaction Approval; Joinder of Spouse of Named Person; Joinder of Spouse of Current Owner; Require Marital Status of Current Owner; Require Marital Status of Named Person; Record Shows Owner is Married; Record Shows Owner is Married—Joinder in Mortgage; Name Change Because of Divorce—Require Copy; Name Change Because of Marriage; Require Statutory Notice of Completion; Inspection to Determine No Commencement; Require Statutory Bond for Recorded Lien; Require Statutory Bond for Project; Require Release; Requirement for Notice to Order Inspection Prior to Close of Transaction; Requirement for Lien Waivers, Financial Statements, etc.; Proof That the Child is Still a Minor; Proof that 18 Years of Age in Current Transaction; Proof of Age in Prior Transaction; Require Guardian, Conservator, Representative; Verify Mobile Home is Attached and Taxes Paid; Payment of Personal Property Taxes; Payment of Lien of Certificate of Title; Surrender of Certificate of Title; Record Affidavit of Affixture; Recorded Affidavit of Affixture; Record Release of Lien by AA; Record Removal Affidavit; Require Release; Proof of Valid Foreclosure; Payoff of Equity Line Loan; Require Delivery of Release by Private Lender; Not Same Person Affidavit; Same Person Affidavit; Liens Against Proposed Grantee; Names of Lender or Purchaser; Affidavit of Identity; Identification and Marital status; Approved by The Secretary of Interior; BIA Report; Tribal Transaction; Require Release of Option; Authority of General Partnership Joint Venture; Authority of Limited Partnerships; Patent Required by Company; Satisfaction of Power of Attorney; Records Show that the Transaction was Executed; Power of Attorney did not Authorize the Transaction; Regulatory Approval; Require Release of Unrecorded Matters; Release of Repurchase/Refusal Rights; Release of Reversionary Clause; Affidavit that Survey is Still Correct; Update Prior Survey; Inspection is Required; Possible Retroactive Taxes; Payment of Prior Taxes; Tax Sale Require Deed from Last Record Owner; Delinquent Assessments; Pending Bankruptcy Against Owner; Copy of Trust; Liens Against Trustee; and Require Release of UCC. The machine controller may utilize machine-based learning to determine the one or more resource effects associated with the above list, including the combined effect of two or more of the above.

Referring to FIG. 19, the scoring update method 1900 comprises receiving an update signal associated with the property information signal (block 1902). The update signal may be associated with a property information signal. The update signal may comprise instruction to associate with and alter one or more of the external grading resources. The associated one of the external grading resources is altered (block 1904). The grade control signal is updated in response (block 1906). The previously determined grade control signal and associated one or more resource effects may be utilized along with the updated one of the external grading resources. The updated external grading resources are compared to the one or more resource effects, resulting in an updated grade control signal. An updated display signal is sent to the machine interface (block 1908). The updated display signal may comprise instructions for the machine interface to display the updated grade control signal. The updated display signal may also comprise instructions to alter the machine interface to indicate the results of the comparison, as well as actions that may alter the comparison. The machine interface may be further altered to enable those actions to be performed via the machine interface.

Referring to FIG. 20, the timed update method 2000 determines a grade time stamp (block 2002). The grade time stamp may be determined when the grade control signal is determined. An update time period is determined (block 2004). Trends based on location, events, and individuals may be utilized to determine an update time period to efficiently update the grade control signal. The update time period may also be pre-determined or input via the machine interface utilizing a property information signal, user signal, or update signal. The time elapsed since the grade time stamp is determined (block 2006). A counter may be utilized to determine the time elapsed since the grade time stamp. Whether the update time period has elapsed is determined (decision block 2008). If the update time period has not elapsed, the time since the grade time stamp is continued to be determined. If the update time period has elapsed, a control signal is sent to retrieve the external grading resources (block 2010).

Referring to FIG. 21, the detected update method 2100 detects that one or more of one or more external control memory structures has been altered (block 2102). Metadata of the external grading resources stored in the one or more external control memory structures, such as version or date of last update, may be detected to indicate that an alteration has been made. A control signal is sent to retrieve the external grading resources from the one or more of the one or more external control memory structures that have been altered in response to detecting that the one or more of the one or more external control memory structures (block 2104).

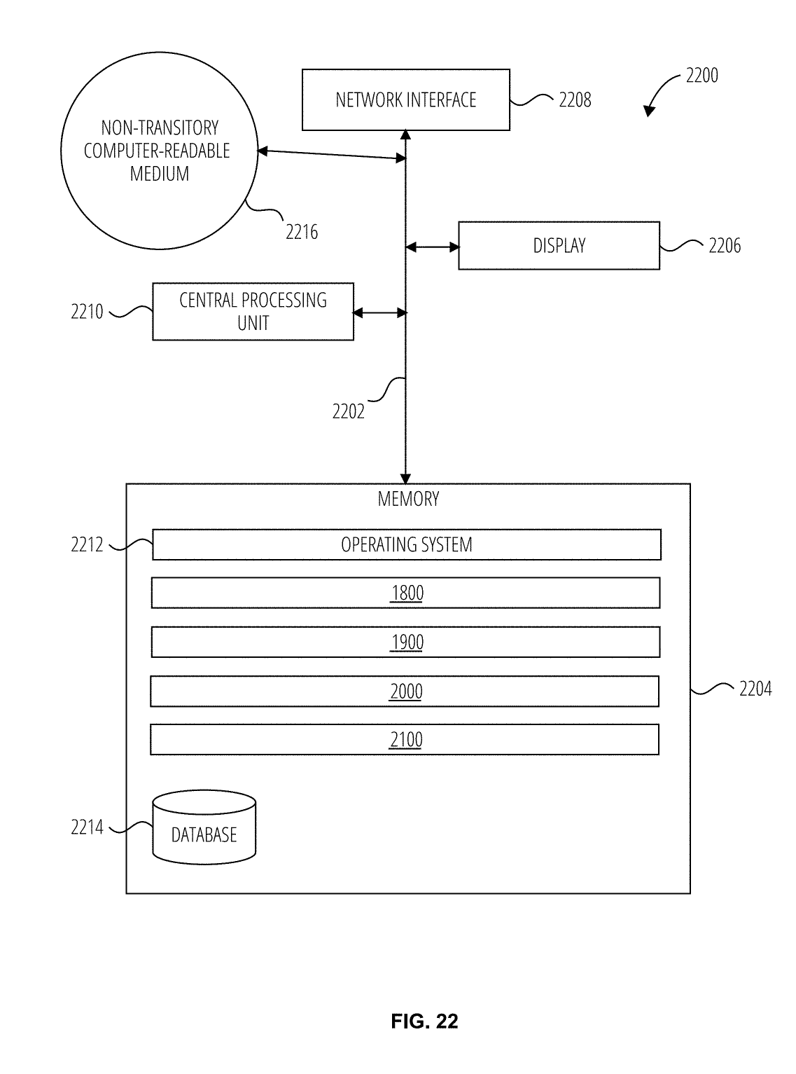

FIG. 22 illustrates several components of an exemplary system 2200 in accordance with one embodiment. In various embodiments, system 2200 may include a desktop PC, server, workstation, mobile phone, laptop, tablet, set-top box, appliance, or other computing device that is capable of performing operations such as those described herein. In some embodiments, system 2200 may include many more components than those shown in FIG. 22. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 2200 may comprise one or more physical and/or logical devices that collectively provide the functionalities described herein. In some embodiments, system 2200 may comprise one or more replicated and/or distributed physical or logical devices.

In some embodiments, system 2200 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 2200 includes a bus 2202 interconnecting several components including a network interface 2208, a display 2206, a central processing unit 2210, and a memory 2204.

Memory 2204 generally comprises a random access memory (“RAM”) and permanent non-transitory mass storage device, such as a hard disk drive or solid-state drive. Memory 2204 stores an operating system 2212.

These and other software components may be loaded into memory 2204 of system 2200 using a drive mechanism (not shown) associated with a non-transitory computer-readable medium 2216, such as a floppy disc, tape, DVD/CD-ROM drive, memory card, or the like.

Memory 2204 also includes database 2214. In some embodiments, system 2200 may communicate with database 2214 via network interface 2208, a storage area network (“SAN”), a high-speed serial bus, and/or via the other suitable communication technology.

In some embodiments, database 2214 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, a compare or comparison may be carried out by a “comparator”, and so on.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Comparator” in this context refers to a logic element that compares two or more inputs to produce one or more outputs that reflects similarity or difference of the inputs. An example of a hardware comparator is an operational amplifier that outputs a signal indicating whether one input is greater, less than, or about equal to the other. An example software or firmware comparator is: if (input 1==input2) output=val1; else if (input 1>input2) output=val2; else output=val3; Many other examples of comparators will be evident to those of skill in the art, without undo experimentation.

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

“Change detector” in this context refers to a device operated by logic that determines whether a control memory structure has been altered and sends a control signal to another device in response. The change detector may be further configured to detect changes for specific stored information in a control memory structure.

“Credential” in this context refers to tokens, passwords and PINs, public-keys, symmetric-keys, SMS-based authentication, biometric authentication, digital identity authentication, etc.

“External grading resources” in this context refers to stored control signals within one or more external control memory structures representing a physical, legal, etc. status.

“Grade control memory structure” in this context refers to a structure to store controls signals to associate property information signals, grade control signals, and credentials.

“Grading control memory structure” in this context refers to define

“Grading processor” in this context refers to a device operating logic to receive external grading resources, resource effects, and stored grade control signals, send control signals to retrieve stored grade control signals, retrieve resource effects associated with the external grading resources, transform the resource effects associated with the external grading resources into a grade control signal, and sends the grade control signal to a grade control memory structure.

“One or more resource effects” in this context refers to values, such as a numerical or alphabetic value, associated with a physical, legal, etc. status of an external grading resources.

“Property information signal” in this context refers to a control signal associated with a physical location, which may include information such as address, GPS coordinates, etc. to determine a specific property.

“Signal” in this context refers to one or more energy impulses that convey control commands, data, or attributes between machine elements or between people, or a combination of machines and people. Any physical entity exhibiting variation in time or variation in space is potentially a signal. Examples of signals include electrical impulses such as analog or binary electrical phenomenon, audio, video, speech, image, communication, geophysical, sonar, radar, and musical signals.

“Update signal receiver” in this context refers to a portion of a machine interface configured to receive an input, such as audio, text, haptic inputs, files, etc., to be associated with a property information signal.

Computer Code Listings

Listing i

```
        calculateGrade( ) {
          curativeItems = getCurativeItems( );
          currentGrade = GRADE_A;
          gradeCount = 0;
          foreach(curativeItem in curativeItems) {
            newGrade = getGradeForCurative(curativeItem);
            if (newGrade > currentGrade) {
              currentGrade = newGrade;
              gradeCount = 1
            }
            if (newGrade === currentGrade) {
              gradeCount = gradeCount + 1;
            }
          }
          // Once we have completed evaluating the
curativeItems, calculate the final grade
          // using the number of occurrences of the worst grade
we found
          finalGrade = currentGrade + (gradeCount *
MULTIPLE_GRADE_SCALING_FACTOR);
          return finalGrade;
        }
```

Listing ii

```
        timerUpdate( ) {
          gradeLastUpdate = getLastGradeUpdateTime( );
          if (gradeLastUpdate < CURRENT_TIME -
UPDATE_FREQUENCY) {
            // Recalculate the grade if sufficient time has
passed since the last evaluation of the grade
            calculateGrade( );
          }
          setTimeout(timerUpdate, SLEEP_TIME);
        }
```

Listing iii

```
gradeChangeCalculator(curativeItems) {
  oldCurativeItems = getCurativeItems( );
  if (curativeItems !== oldCurativeItems) {
    setCurativeItems(curativeItems);
    return calculateGrade( );
  }
  return getCurrentGrade( );
}
```

What is claimed is:

1. A system comprising:
a machine interface to:
display one or more activation controls on a machine display;
receive an input at one of the one or more activation controls;
display one or more display activation controls on the machine display, the one or more display activation controls comprising a status of external grading resources;
the one or more display activation controls configured to receive an update signal associated with one or more of the external grading resources, the update signal comprising a first set of instructions for the system to:
determine one or more external control memory structures associated with the update signal;
send a second set of instructions to the one or more external control memory structures associated with the update signal to update the external grading resources in the one or more external control memory structures;
re-determine a grade control signal; and
alter a display signal based on an updated status of the external grading resources;
a machine controller to:
determine the external grading resources for processing;
send a resource control signal to the one or more external control memory structures, the resource control signal comprising a third set of instructions to retrieve the external grading resources;
receive the external grading resources; and
convert the grade control signal into the display signal;
a grading processor to:
associate each of the external grading resources with one or more of one or more resource effects; and
generate the grade control signal from the one or more of the one or more resource effects associated with each of the external grading resources; and
a resource effect control memory structure comprising the one or more resource effects.

2. The system of claim 1, wherein the machine interface displays the one or more activation controls on the machine display in response to receiving a location.

3. The system of claim 1, wherein the machine interface determines a configuration of the machine display and alters one or more of the one or more activation controls, the one or more display activation controls, and the status of the external grading resources.

4. The system of claim 3, wherein the configuration comprises a web-based browser display configuration or a mobile-based browser display configuration.

5. The system of claim 1, wherein in response to a selection of one of the one or more display activation controls, the machine interface configures the machine display to overlay an update signal receiver, the update signal receiver configured to receive the update signal.

6. The system of claim 5, wherein the update signal receiver slides from an edge of the machine display.

7. The system of claim 5, wherein the update signal receiver has an origin point from the one of the one or more display activation controls activated.

8. The system of claim 5, wherein the update signal receiver partially overlays the machine display.

9. The system of claim 8, wherein the update signal receiver partially overlays up to 10%, up to 20%, up to 30%, up to 40%, up to 50%, up to 60%, up to 70%, up to 80%, or up to 90%.

10. The system of claim 1 further comprising a grade control memory structure, the grade control memory structure configured to store the grade control signal and a property information signal associated with the grade control signal.

11. The system of claim 10, wherein the machine interface is further configured to receive a user signal, the user signal comprising a credential and instructions to associate the credential with one or more of the property information signals and store the credential in the grade control memory structure.

12. The system of claim 1 further comprising an update timer, the update timer configured to:
receive an update time period signal, the update time period signal comprising instructions for the update timer to send a control signal to the machine controller to send the resource control signal to the one or more external control memory structures after an update time period has elapsed;
receive an initial time indicator;
determine whether the update time period has elapsed; and
send the control signal to the machine controller in response to determining that the update time period has elapsed.

13. The system of claim 1 further comprising a change detector, the change detector configured to:
send a first control signal to the one or more external control memory structures to determine if the one or more external control memory structures have been updated; and
in response to the one or more external control memory structures being updated, send a second control signal to the machine controller, the second control signal comprising instructions for the machine controller to send the resource control signal to the one or more external control memory structures.

14. The system of claim 13, wherein the machine controller sends a control signal to the change detector, the control signal comprising further instructions for the change detector to send the control signal to a subset of the one or more external control memory structures.
